(19) United States
(12) Patent Application Publication
(10) Pub. No.: US 2024/0424577 A1
(43) Pub. Date: Dec. 26, 2024

(54) CUTTING HEAD WITH FASTENING RECESS AND CUTTING ARMS HAVING DOVETAIL REAR ABUTMENT SURFACE, TOOL HOLDER AND ROTARY CUTTING TOOL

(71) Applicant: ISCAR, LTD., TEFEN (IL)

(72) Inventor: GIL HECHT, NAHARIYA (IL)

(73) Assignee: ISCAR, LTD., TEFEN (IL)

(21) Appl. No.: 18/341,317

(22) Filed: Jun. 26, 2023

(51) Int. Cl. B23B 27/16; B23B 51/00

(52) U.S. Cl. CPC B23B 27/16; B23B 51/0007

(57) ABSTRACT

A cutting head has two radially extending cutting arms and at least one fastening recess having an opening located at least partially on one of cutting arms. Each cutting arm has a dovetail arm rear abutment surface. A tool holder has a two circumferentially spaced apart driving members. The tool holder has a pocket with two radially extending arm receiving receptacle. Each receptacle has a dovetail receptacle rear abutment surface. The tool holder has at least one through hole located in one of the driving members. When assembled, a fastening member is disposed in the through bore and engages with the fastening recess to urge each cutting arms towards a respective driving member.

### FIELD OF THE INVENTION

The subject matter of the present application relates to rotary cutting tools of the type in which a cutting head is releasably retained in a tool holder by means of a coupling mechanism.

### BACKGROUND OF THE INVENTION

Rotary cutting tools can include a cutting head releasably attached to a tool holder. The cutting head can include at least two radially extending cutting arms. The tool holder can include at least two driving members which define a pocket having at least two radially extending arm receiving receptacles, where the number of cutting arms, driving members and arm receiving receptacles all match other. Such rotary cutting tools can be provided with a coupling mechanism for securely retaining the cutting head within the pocket. The coupling mechanism can include at least one fastening member to releasably retain the cutting head in the pocket, thereby forming an assembled state of the rotary cutting tool. In the assembled state, the cutting arms are in abutment with the driving members.

In some such rotary cutting tools, the cutting head is clamped by one or more clamping screws. Each clamping screw is located in a through hole formed in a respective cutting arm and threadingly engaged with a threaded hole in a respective driving member. An example of such rotary cutting tools is disclosed in, for example, U.S. Pat. No. 6,530,728, where a locking screw (of the grub screw variety) is threadingly engaged with an internal thread formed in a hole on the drill body and brought into contact with a leading surface of a wing and urges the replaceable drill tip to rotate so that a second support surface in the cutting seat abuts a third support surfaces on the drill tip

In other such rotary cutting tools, the cutting head is clamped by one or more locking screws. The locking screw is located in a through hole on the cutting arm and threadingly engaged with a threaded hole in the driving member. An example of such rotary cutting tools is disclosed in, for example, EP1136161 B1.

In yet other such rotary cutting tools, the cutting head is clamped between the driving members. The clamping screw is located in a first through hole in one of the driving members and a second through hole in the cutting head and threadingly engaged in a threaded hole in the other driving member. The two driving members are urged towards each other and clamp the cutting head. An example of such rotary cutting tools is disclosed in, for example, U.S. Pat. No. 6,514,019.

### SUMMARY OF THE INVENTION

In accordance with a first aspect of the subject matter of the present application there is provided a cutting head having a head central axis defining opposite forward to rearward direction and about which the cutting head is rotatable in a rotational direction, the cutting head comprising a cutting portion;
the cutting portion comprising:
   opposite head front and rear end surfaces and a head peripheral surface extending therebetween;
   two cutting arms, each cutting arm extending radially outwards with respect to the head central axis along an arm axis and comprising:
      opposite arm rotationally leading and trailing surfaces located on the head peripheral surface, the arm rotationally leading surface being ahead of the arm rotationally trailing surface in the rotational direction;
      a forwardly disposed major cutting edge formed along at least a portion of an intersection of the arm rotationally leading surface and the head front surface;
      an arm rear abutment surface located on the head rear surface, the arm rear abutment surface sloping forwardly in a direction away from the arm rotationally trailing surface towards the arm rotationally leading surface;
      a driven surface located on the arm rotationally trailing surface; and
   at least one fastening recess opening out at a recess opening located at least partially on the arm rotationally trailing surface of a respective cutting arm associated with the at least one fastening recess; wherein:
      the at least one fastening recess comprises a recess circumferential surface extending about a recess central axis, the recess circumferential surface comprising a recess abutment surface oriented transversely to the head central axis and facing away from the head rear surface.

In accordance with a second aspect of the subject matter of the present application there is provided a tool holder, having a holder longitudinal axis, extending in opposite forward to rearward direction and about which the tool holder is rotatable in a rotational direction, the tool holder comprising:
a holder peripheral surface extending circumferentially along the holder longitudinal axis and forming a boundary of a forwardly facing holder base surface at a forward end of the tool holder;
two circumferentially spaced apart holder flutes recessed in the holder peripheral surface and extending helically about the holder longitudinal axis;
two circumferentially spaced apart driving members extending forwardly from the holder base surface, each driving member comprising:
   driving member rotationally leading and trailing surfaces, the driving member rotationally leading surface being ahead of the driving member rotationally trailing surface in the rotational direction;
   a driving surface located on the driving member rotationally leading surface, and
   at least one driving member through hole extending along a driving member through hole axis and opening out to the driving member rotationally leading surface and the holder peripheral surface; and
a head receiving pocket formed between the two circumferentially spaced apart driving members, the head receiving pocket comprising two arm receiving receptacles, each arm receiving receptacle extending radially outwards with respect to the holder longitudinal axis along a receptacle axis and merging with an associated respective holder flute in the rotation direction and being delimited by an associated respective driving member in a direction opposite the rotational direction; wherein:
   each arm receiving receptacle comprises a receptacle rear abutment surface located on the holder base surface; and
   for any given arm receiving receptacle and its associated holder flute and its associated driving member, the receptacle rear abutment surface slopes forwardly in a direction away from the associated driving member towards the associated holder flute.

In accordance with a third aspect of the subject matter of the present application there is provided a rotary cutting tool comprising:
a cutting head, of the type described above;
a tool holder having a holder longitudinal axis, extending in opposite forward to rearward direction and about which the tool holder is rotatable; and
at least one fastening member; wherein:
   the rotary cutting tool is adjustable between a released position, and a fastened position in which the cutting head is releasably attached to the tool holder by the at least one fastening member.

In accordance with a fourth aspect of the subject matter of the present application there is provided a rotary cutting tool comprising:
a cutting head, of the type described above;
a tool holder, of the type described above: and
at least one fastening member; wherein:
the rotary cutting tool is adjustable between a released position and a fastened position, wherein, in the fastened position:
   the cutting head is releasably attached to the tool holder by the at least one fastening member;
   the head centering pin is located in the holder centering hole;
   each cutting arm is located in a respective arm receiving receptacle;
   each driven surface abuts a respective driving surface;
   each arm rear abutment surface abuts a respective receptacle abutment surface; and
   the at least one fastening member engages the recess abutment surface of the at least one fastening recess.

In accordance with a fifth aspect of the subject matter of the present application there is provided a cutting head having a head central axis defining opposite forward to rearward direction and about which the cutting head is rotatable in a rotational direction, the cutting head comprising a cutting portion;
the cutting portion being devoid of insert seats configured to receive a cutting insert, and comprising:
   opposite head front and rear end surfaces and a head peripheral surface extending therebetween;
   two cutting arms, each cutting arm extending radially outwards with respect to the head central axis along an arm axis and comprising:
      opposite arm rotationally leading and trailing surfaces located on the head peripheral surface, the arm rotationally leading surface being ahead of the arm rotationally trailing surface in the rotational direction;
      a forwardly disposed major cutting edge formed along at least a portion of an intersection of the arm rotationally leading surface and the head front surface;
      an arm rear abutment surface located on the head rear surface;
      a driven surface located on the arm rotationally trailing surface; and
   at least one fastening recess opening out at a recess opening located at least partially on the arm rotationally trailing surface of a respective cutting arm associated with the at least one fastening recess; wherein:
      the at least one fastening recess comprises a recess circumferential surface extending about a recess central axis, the recess circumferential surface comprising a recess abutment surface oriented transversely to the head central axis and facing away from the head rear surface; and
      the at least one fastening recess is blind and does not penetrate the entire thickness of the respective cutting arm so as to intersect both the rotationally leading surface and the rotationally trailing surface of said respectively cutting arm.

It is understood that the above-said is a summary, and that features described hereinafter may be applicable in any combination to the subject matter of the present application, for example, any of the following features may be applicable to the rotary cutting tool, cutting head or tool holder:

The recess central axis can intersect the head central axis.

For any given fastening recess and its associated cutting arm, the recess abutment surface can converge with the arm rear abutment surface in a direction away from the arm rotationally trailing surface towards the arm rotationally leading surface.

The cutting head can further comprise a centering portion. The head rear surface can define a boundary between the cutting portion and the centering portion. The centering portion can comprise a head centering pin protruding rearwardly from the head rear surface along the head central axis.

In a view along the arm axis, the recess abutment surface and the arm rear abutment surface can form an acute arm engagement angle. The arm engagement angle can be greater than or equal to 5° and less than or equal to 10°.

In a view along the arm axis, the arm rear abutment surface can form an acute arm rear dovetail angle with a radial head plane oriented perpendicularly to the head central axis. The arm rear dovetail angle can be greater than or equal to 10° and less than or equal to 30°.

The recess abutment surface can slope forwardly in a direction away from the recess opening.

In a view along the arm axis, the recess abutment surface can form a recess abutment angle with a radial head plane oriented perpendicularly to the head central axis. The recess abutment angle can be greater than or equal to 15° and less than or equal to 25°.

The cutting portion can comprise exactly two cutting arms diametrically opposed to one another about the head central axis.

The cutting portion can comprise exactly two fastening recesses, each fastening recess being associated with a different cutting arm.

The cutting portion can comprise a head radially central portion. The exactly two cutting arms can extend radially outwardly from the head radially central portion. The cutting portion can comprise exactly two opposing chip breaker wings extending radially outwardly from the head radially central portion, each chip breaker wing being located between the exactly two cutting arms.

The exactly two cutting arms can define a head outer diameter. The exactly two chip breaker wings can define a wing spanning dimension measured in a direction normal to the driven surfaces. The wing spanning dimension can be greater than half the head outer diameter.

The cutting portion can be devoid of insert seats configured to receive a cutting insert.

The at least one fastening recess can be blind and may not penetrate the entire thickness of the respective cutting arm so as to intersect both the rotationally leading surface and the rotationally trailing surface of said respectively cutting arm.

The through hole central axis can intersect the holder longitudinal axis.

The tool holder can further comprise a holder centering hole recessed in the holder base surface and extending along the holder longitudinal axis in the rear direction.

The tool holder can comprise exactly two circumferentially spaced apart driving members.

The tool holder can comprise exactly two driving member through holes, each driving member through hole being formed in a different driving member.

In a view along the receptacle axis, the receptacle rear abutment surface can form an acute receptacle rear dovetail angle with a radial holder plane oriented perpendicularly to the holder longitudinal axis. The receptacle rear dovetail angle can be greater than or equal to 10° and less than or equal to 30°.

The driving member through hole can comprise a through hole peripheral surface extending about the through hole central axis. The through hole peripheral surface can comprise an internal thread.

The at least one fastening member can be a grub screw having an external thread threadingly engaged with the internal thread.

The rotary cutting tool can comprise exactly two fastening members.

### BRIEF DESCRIPTION OF THE FIGURES

For a better understanding of the present application and to show how the same may be carried out in practice, reference will now be made to the accompanying drawings, in which:

FIG. 1 is a perspective view of a rotary cutting tool in accordance with an embodiment of the present application;

FIG. 2 is an exploded perspective view of a forward end of the rotary cutting tool shown in FIG. 1;

FIG. 3 is a front view of a cutting head shown in FIGS. 1 and 2, showing two hidden fastening recesses;

FIG. 4 is a major side view of the cutting head shown in FIG. 3, viewed along an arm axis, showing two hidden fastening recesses;

FIG. 5 is a minor side view of the cutting head shown in FIG. 4, where the cutting head is rotated 90° about a head central axis;

FIG. 6 is another side view of the cutting head shown in FIG. 3, viewed along a recess central axis;

FIG. 7 is a rear view of the cutting head shown in FIG. 3;

FIG. 8 is a perspective view of a tool holder shown in FIGS. 1 and 2;

FIG. 9 is a front view of the tool holder shown in FIG. 8;

FIG. 10 is a major side view of a forward end of the tool holder shown in FIG. 8;

FIG. 11 is a minor side view of the forward end shown in FIG. 10, where the tool holder is rotated 90° about a holder central axis;

FIG. 12 is a cross-sectional view of the tool holder taken along the line XII-XII in FIG. 10;

FIG. 13 is a side view of a fastening member;

FIG. 14 is a front view of the forward end of the rotary tool holder shown in FIG. 1;

FIG. 15 is a major side view of the forward end of the rotary tool holder shown in FIG. 14;

FIG. 16 is a cross-sectional view of the rotary cutting tool taken along the line XVI-XVI in FIG. 14; and

FIG. 17 is a cross-sectional view of the rotary cutting tool taken along the line XVII-XVII in FIG. 15.

It will be appreciated that for simplicity and clarity of illustration, elements shown in the figures have not necessarily been drawn to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following description, various aspects of the subject matter of the present application will be described. For purposes of explanation, specific configurations and details are set forth in sufficient detail to provide a thorough understanding of the subject matter of the present application. However, it will also be apparent to one skilled in the art that the subject matter of the present application can be practiced without the specific configurations and details presented herein.

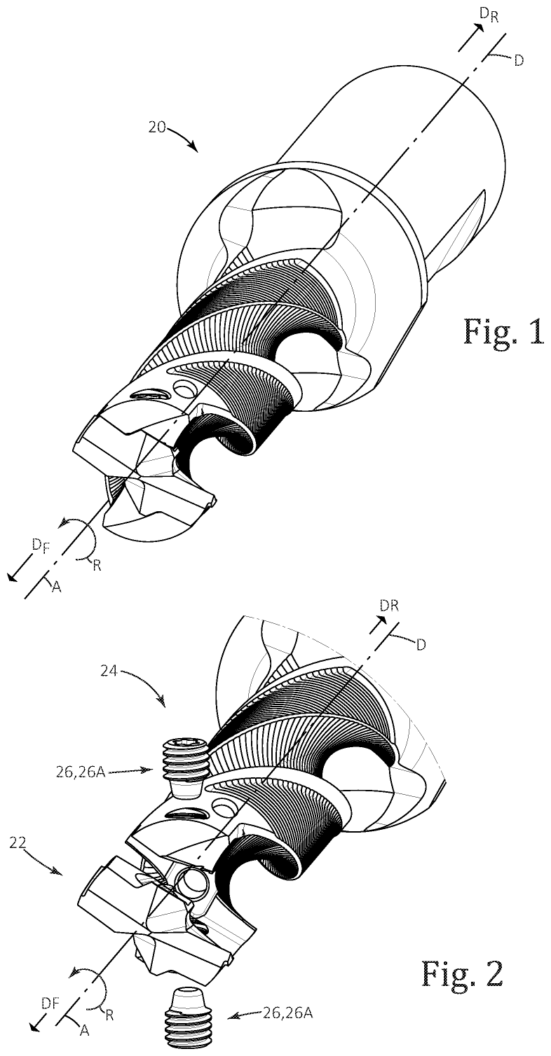

Attention is first drawn to FIGS. 1 and 2 showing a rotary cutting tool 20, of the type used for drilling operations, in accordance with embodiments of the subject matter of the present application. The rotary cutting tool 20 has a cutting head 22 which can be typically made from cemented carbide. The rotary cutting tool 20 also has a tool holder 24, complementary to the cutting head 22, which can be typically made from steel. The rotary cutting tool 20 is adjustable, at least, between a released and fastened position. In the fastened position of the rotary cutting tool 20, the cutting head 22 is releasably attached in the tool holder 24, by at least one fastening member 26.

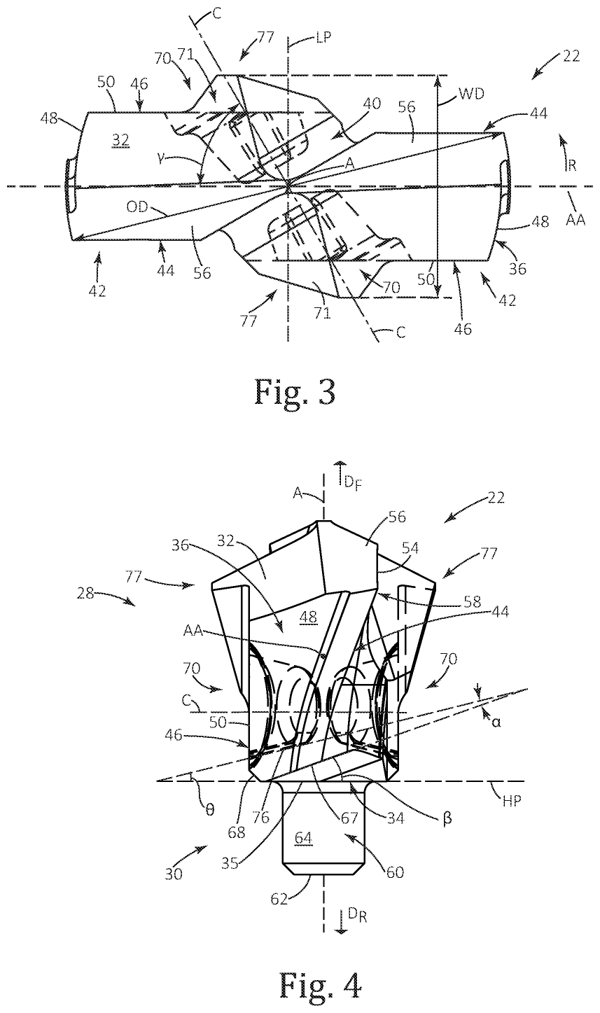

Reference is now made to FIGS. 3 to 6, showing the cutting head 22, in accordance with the subject matter of the present application. The cutting head 22 is made from a unitary integral one-piece (monolithic) construction. The cutting head 22 has a head central axis A about which the cutting head 22 is rotatable in a rotational direction R, where the rotational direction R is the cutting direction. In accordance with some embodiments of the subject matter of the present application the head central axis A can be a longitudinal axis. The head central axis A extends in the forward to rearward directions D_{F}, D_{R}. As seen best in FIGS. 4 to 6, the cutting head 22 includes a cutting portion 28. The cutting head 22 has a radial head plane HP oriented perpendicularly to the head central axis A. In the drawings, the radial head plane HP is shown as being located at the head rear surface 34. In accordance with some embodiments of the subject matter of the present application, the cutting head 22 can include a centering portion 30, in which case the cutting portion 28 is formed at a forward end of the cutting head 22 and the centering portion 30 is formed at a rear end of the cutting head 22. It should be understood that use of the terms “forward” and “rearward” throughout the description and claims refer to a relative position in the direction of the head central axis A towards the up and down directions, respectively, in FIGS. 4 to 6.

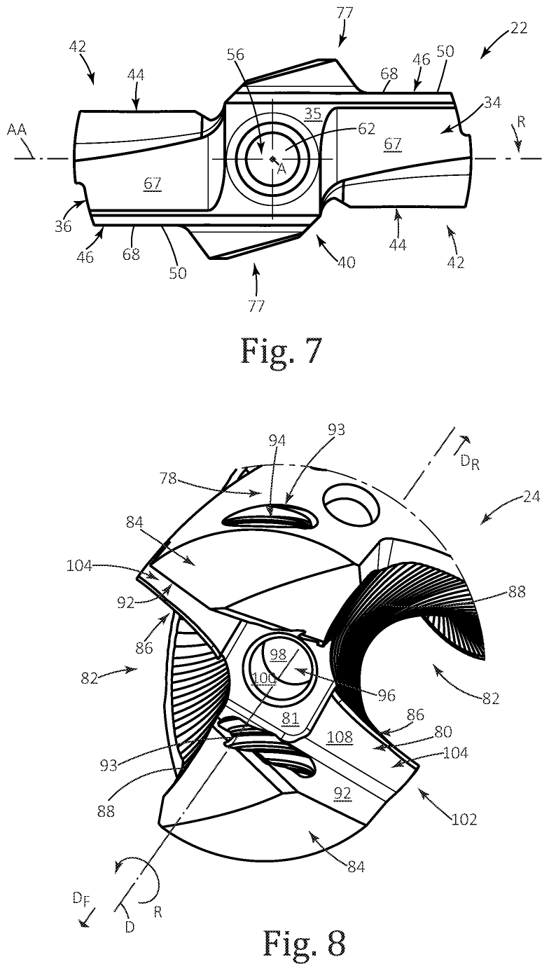

The cutting portion 28 includes opposing head front and rear surface 32, 34 and a head peripheral surface 36 that extends between the head front and rear surfaces 32, 34. The head central axis A extends through the head front and rear surface 32, 34. The head rear surface 34 defines a boundary between the cutting portion 28 and the centering portion 30. Referring to FIGS. 4 and 7, in accordance with some embodiments of the subject matter of the present application, the head rear surface 34 can include a head central rear surface 35 which is planar and oriented perpendicular to the head central axis A. The head central rear surface 35 can define (i.e., be contained in) the radial head plane HP.

The cutting portion 28 includes a head radially central portion 40. The cutting portion 28 includes two cutting arms 42 that extend radially outwards, with respect to the head longitudinal axis A, from the head radially central portion 40. Each cutting arm 42 is configured to be seated in a respective arm receiving receptacle 104 and be coupled with a respective driving member 84, as described later in the description. Each cutting arm 42 extends radially outwards along an arm axis AA. The cutting portion 28 can exhibit rotation symmetry about the head central axis A. Referring to FIG. 3, the two cutting arms 42 define a head outer diameter OD. In this non-limiting example shown in the drawings, the cutting portion 28 includes exactly two cutting arms 42, diametrically opposed to each other about the head central axis A. The arm axis AA intersects the head central axis A.

As seen best in FIG. 3, each cutting arm 42 respectively includes opposing arm rotationally leading and trailing surfaces 44, 46 and an arm peripheral surface 48 that extends peripherally between that arm's rotationally leading and trailing surfaces 44, 46. The arm rotationally leading and trailing surfaces 44, 46 and the arm peripheral surface 48 are all located on the head peripheral surface 36. The arm axis AA intersects the arm peripheral surface 48. It should be understood that use of the terms “rotationally leading” and “rotationally trailing” throughout the description and claims refer to a position relative to the head rotational direction R. Thus, the arm rotationally leading surface 44 is ahead of the arm rotationally trailing surface 46 in the rotational direction R. Each cutting arm 42 includes a driven surface 50 for driven engagement by a complementary surface on the tool holder 24. The driven surface 50 is located on the arm rotationally trailing surface 46. As seen in FIG. 4, in this non-limiting example, each driven surface 50 can be planar. Moreover, each driven surface 50 can be parallel to the head central axis A.

As seen from FIGS. 3-7, this embodiment of the cutting head 22 is devoid of insert seats configured to accommodate cutting inserts having cutting edges.

Referring to FIG. 4, each cutting arm 42 includes a respective major cutting edge 54. The major cutting edge 54 is forwardly disposed, that is formed at a forward end of the cutting head 22. The major cutting edge 54 is formed along at least a portion of the intersection of the arm rotationally leading surface 44 and the head front surface 32. The head front surface 32 includes a plurality of major relief surfaces 56. Each major relief surface 56 extends from the respective major cutting edge 54 to which it is associated towards the opposite arm rotationally trailing surface 46 on the same cutting arm 42. Each arm rotationally leading surface 44 includes a respective major rake surface 58. Each major rake surface 58 extends from the major cutting edge 54 to which it is associated towards the head rear surface 34. As is known in the field of rotary cutting tools, each cutting arm 42 can include a cutting arm flute 59, associated to a respective major cutting edge 54, for the evacuation of chips.

As seen best in FIGS. 4 to 6, in accordance with some embodiments of the subject matter of the present application, the centering portion 30 can include a head centering pin 60 that protrudes rearwardly from the head rear surface 34 along the head central axis A. The purpose of the head centering pin 60 is to provide a centering means with the tool holder 24. The head centering pin 60 includes a pin rear surface 62 that is spaced apart from the head rear surface 34 and a pin peripheral surface 64 that extends between the pin rear surface 62 and the head rear surface 34. The head centering pin 60 can protrude from the planar head central rear surface 35. The pin peripheral surface 64 can have a cylindrical shape. The pin peripheral surface 64 can be devoid of a notch, for securing purposes, of the type disclosed in for example U.S. Pat. No. 9,468,979. The head rear surface 34 can form a peripheral boundary of the pin peripheral surface 64 at the region where the head centering pin 60 protrudes from the head rear surface 34. The head centering pin 60 may be rotationally symmetrical about the head central axis A.

The at least one cutting arm 42 includes an arm rear abutment surface 67 located on the head rear surface 34. As seen in FIG. 4, the arm rear abutment surface 67 slopes forwardly in a direction away from the arm rotationally trailing surface 46 towards the arm rotationally leading surface 44. Stated differently, the arm rear abutment surface 67 has a dovetail configuration. In a view along the arm axis AA (i.e., FIG. 4), the arm rear abutment surface 67 forms an acute arm rear dovetail angle β with the radial head plane HP. In accordance with some embodiments of the subject matter of the present application, the arm rear dovetail angle β can fulfill the condition: 10°≤β≤30°. Preferably, the arm rear dovetail angle β can be equal to 20°.

Referring again to FIG. 4, in accordance with some embodiments of the subject matter of the present application, the arm rear abutment surface 67 can be planar. The arm rear abutment surface 67 can be spaced apart from the arm rotationally trailing surface 46 by an arm chamfer surface 68.

Referring in particular to FIGS. 3 and 4, the cutting portion 28 includes at least one fastening recess 70 which extends along a recess central axis C. The at least one fastening recess 70 is “hidden” and so is shown with dashed lines.

The at least one fastening recess 70 opens out at a recess opening 71. The recess opening 71 is located at least partially on the arm rotationally trailing surface 46 of a respective cutting arm 42 which is associated with the at least one fastening recess 70. That is to say, the at least one fastening recess 70 is associated with a respective cutting arm 42. In accordance with some embodiments of the subject matter of the present application, the cutting portion 28 can include exactly two fastening recesses 70, each being associated with a different cutting arm 42. In FIG. 3, the left sided “hidden” fastening recess 70 is associated the left-sided cutting arm 42 and vice versa.

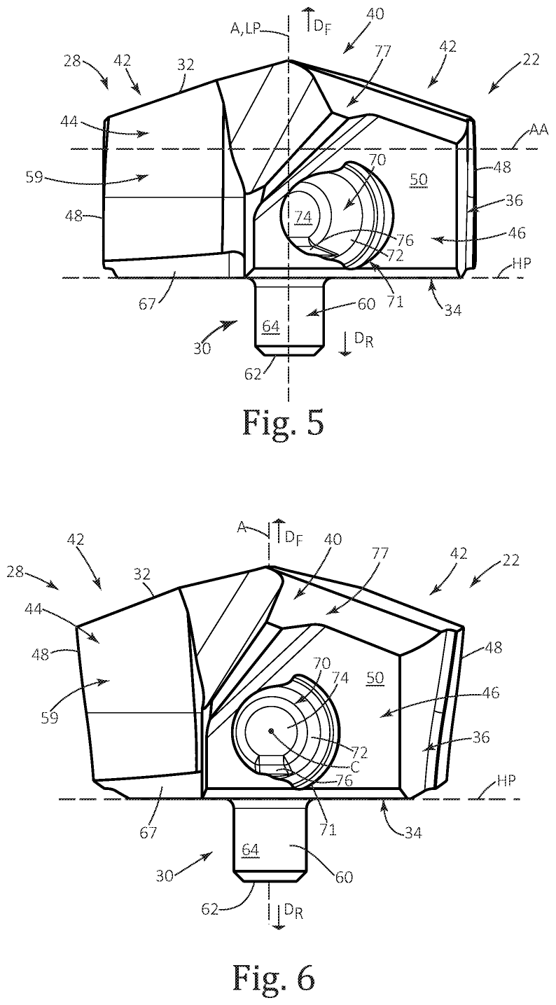

Referring to FIGS. 5 and 6, in accordance with some embodiments of the subject matter of the present application, the recess opening 71 is located partially on the arm rotationally trailing surface 46. A majority of the recess opening 71 can be located on the arm rotationally trailing surface 46. A minority of the recess opening 71 can be located on the arm rotationally leading surface 44 of the rotationally succeeding cutting arm 42. This shown in FIGS. 3 and 5, where the recess opening 71 extends across a longitudinal head plane LP which contains the head longitudinal axis A and oriented perpendicular to the arm axis AA.

The at least one fastening recess 70 includes a recess circumferential surface 72 which extends about the recess central axis C. It is noted that the recess opening 71 is defined by the intersection of the recess circumferential surface 72 with the arm rotationally trailing surface 46 and optionally the arm rotationally leading surface 44. In accordance with some embodiments of the subject matter of the present application, the fastening recess 70 can include a recess bottom surface 74 which is bounded by the recess circumferential surface 72 and intersected by the recess central axis C. The fastening recess 70 can be blind in which case it does not penetrate the entire thickness of an associated cutting arm 42 so as intersect both the rotationally leading surface 44 and the rotationally trailing surface 46 of that associated cutting arm 42.

In accordance with some embodiments of the subject matter of the present application, as seen in FIG. 3 (i.e., in a view along the head central axis A), the recess central axis C can be perpendicular to the head central axis A. The recess central axis C can intersect the head central axis A. Thus, in a configuration with exactly two fastening recess 70, the two fastening recesses 70 are co-axial. Beneficially, each fastening recess 70 is thus directed towards the head radially central portion 40, thereby maintaining rigidity of the two cutting arms 42.

As seen in FIG. 3, in a view along the head central axis A, the recess central axis C forms an acute recess angle γ with the arm axis AA. The acute recess angle γ can fulfill the condition: 50°≤γ≤70°. Preferably, the acute recess angle γ can be equal to 60°. In accordance with some other embodiments of the subject matter of the present application, the recess central axis C can be offset from (i.e., not intersect) the head central axis A (not shown).

Referring back to FIG. 5, the recess circumferential surface 72 includes a recess abutment surface 76 oriented transversely to the head central axis A and which faces away from the head rear surface 34. Generally speaking, the recess abutment surface 76 extends along the recess central axis C. In accordance with some embodiments of the subject matter of the present application, the recess abutment surface 76 can be planar. The recess abutment surface 76 can slope forwardly into the associated cutting arm 42, in a direction away the recess opening 71 (e.g. from the arm rotationally trailing surface 46 towards the arm rotationally leading surface 44). In a major side view along the arm axis AA (FIG. 4), the recess abutment surface 76 can form a recess abutment angle θ with the radial head plane HP. The forward sloping recess abutment angle θ can fulfill the condition: 15°≤θ≤25°. The fastening recess 70 and especially its recess circumferential surface 72 and/or recess abutment surface 76 can be unthreaded—i.e., lack an internal thread of the sort configured to engage an externally threaded fastening member.

In accordance with some embodiments of the subject matter of the present application, for any given fastening recess 70 and its associated cutting arm 42, the recess abutment surface 76 can converge with the sloping arm rear abutment surface 67 in a direction away from the arm rotationally trailing surface 46 towards the arm rotationally leading surface 44. Thus, the arm rear dovetail angle β is greater than the recess abutment angle θ. In a view along the arm axis AA, the recess abutment surface 76 and the sloping arm rear abutment surface 67 form an acute arm engagement angle α. The arm engagement angle α can fulfill the condition: 3°≤α≤20°. Preferably, the arm engagement angle α can fulfill the condition: 5°≤α≤10°.

In the configuration with exactly two cutting arms 42, in accordance with some embodiments of the subject matter of the present application, the cutting portion 28 can include exactly two opposing chip breaker wings 77 which extend radially from the head radially central portion 40. Each chip breaker wing 77 can be located between the exactly two cutting arms 42. Each chip breaker wing 77 can extend to the head front surface 32 in the forward direction D_{F}. Each chip breaker wing 77 may not extend to the head rear surface 34 in the rearward direction D_{R}. Stated differently, each chip breaker wing 77 can be spaced apart from the head rear surface 34. Each chip breaker wing 77 can form part of a respective cutting arm flute 59. Advantageously, the chip breaker wings strengthen the cutting portion 28 and improve chip flow and evacuation. The exactly two chip breaker wings 77 can define a wing spanning dimension WD measured in a direction normal to the driven surfaces 50. The chip breaker wings 77 can be radially shorter than the cutting arms 42. In particular, the wing spanning dimension WD can be greater than half the head outer diameter OD. The wing spanning dimension WD can be less than three-quarters the head outer diameter OD.

Another aspect of the subject matter of the present application includes a tool holder 24, for releasably attaching the cutting head 22 thereto.

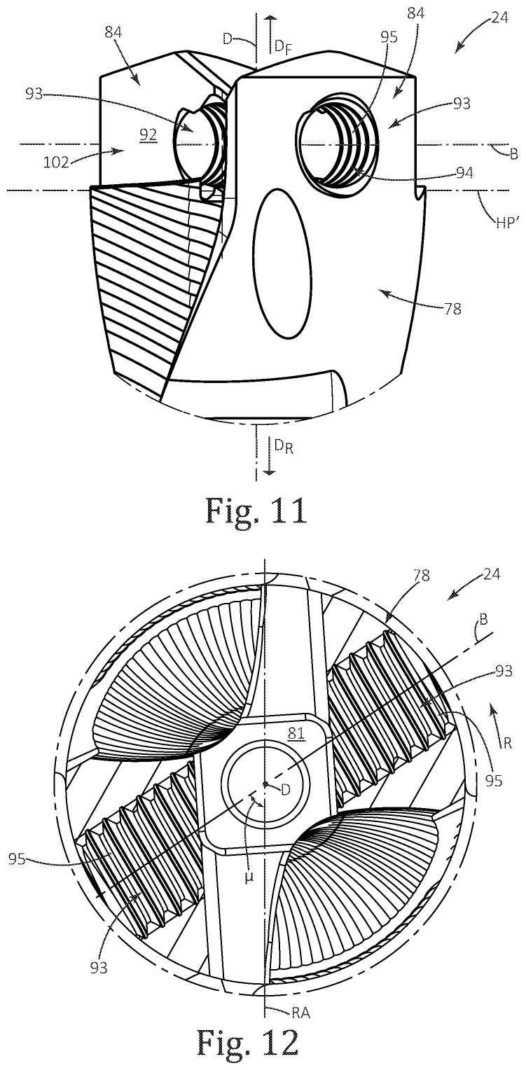

Attention is drawn to FIGS. 8 to 12 showing the tool holder 24, in accordance with the subject matter of the present application. The tool holder 24 has a holder longitudinal axis D that extends in the forward to rearward direction D_{F}, D_{R} and about which the tool holder 24 is rotatable in the rotational direction R. The tool holder 24 includes a holder peripheral surface 78 that extends circumferentially along the holder longitudinal axis D. The holder peripheral surface 78 forms a boundary of a forwardly facing holder base surface 80 at a forward end of the tool holder 24. The tool holder 24 has a radial holder plane HP′ oriented perpendicularly to the holder longitudinal axis D. In accordance with some embodiments of the subject matter of the present application, the holder base surface 80 can include a holder central base surface 81 which is planar and oriented perpendicular to the holder longitudinal axis D. The holder central base surface 81 can define (i.e., be contained in) the radial holder plane HP′.

The tool holder 24 includes circumferentially spaced apart two holder flutes 82 recessed in the holder peripheral surface 78 and extending helically about the holder longitudinal axis D.

The tool holder 24 includes two circumferentially spaced apart driving members 84 that extend forwardly from the holder base surface 80. The driving members 84 serve to impart a cutting torque to the cutting head 22 when the tool holder 24 rotates. In this non-limiting example shown in the drawings, the tool holder 24 includes exactly two driving members 84, diametrically opposed to each other about the holder longitudinal axis D. Each driving member 84 includes opposing driving member rotationally leading and trailing surfaces 86, 88 and a driving member peripheral surface 90 that extends peripherally between the driving member rotationally leading and trailing surfaces 86, 88. The driving member rotationally leading surface 86 is ahead of the driving member rotationally trailing surface 88 in the rotational direction R.

The driving member rotationally leading surface 86 includes a driving surface 92 for driven engagement with a respective complementary driven surface 50 on the cutting head 22. In accordance with some embodiments of the subject matter of the present application, the driving surfaces 92 can be located axially forward of the the holder base surface 80. The driving surfaces 92 can be planar.

The tool holder 24 includes a driving member through hole 93 formed in a respective driving member 84. The driving member through hole 93 extends along a through hole central axis B. In accordance with some embodiments of the subject matter of the present application, the tool holder 24 can include exactly two driving member through holes 93, each driving member through hole 93 being formed in a different driving member 84.

The driving member through hole 93 opens out to the driving member rotationally leading surface 86 (of the driving member through hole 93 in which it is formed) and the holder peripheral surface 78. The driving member through hole 93 can include a through hole peripheral surface 94 which extends about the through hole central axis B. In accordance with some embodiments of the subject matter of the present application, the through hole peripheral surface 94 can include an internal thread 95.

In accordance with some embodiments of the subject matter of the present application, as seen in FIG. 12 (i.e., in a view along the holder longitudinal axis D), the through hole central axis B can intersect the holder longitudinal axis D. Thus, in a configuration with exactly two driving member through holes 93, the two driving member through holes 93 are co-axial. The through hole central axis B forms an acute through hole angle μ with the receptacle axis RA. The acute through hole angle μ can fulfill the condition: 50°≤μ≤70°. Preferably, the acute through hole angle μ can be equal to 60°.

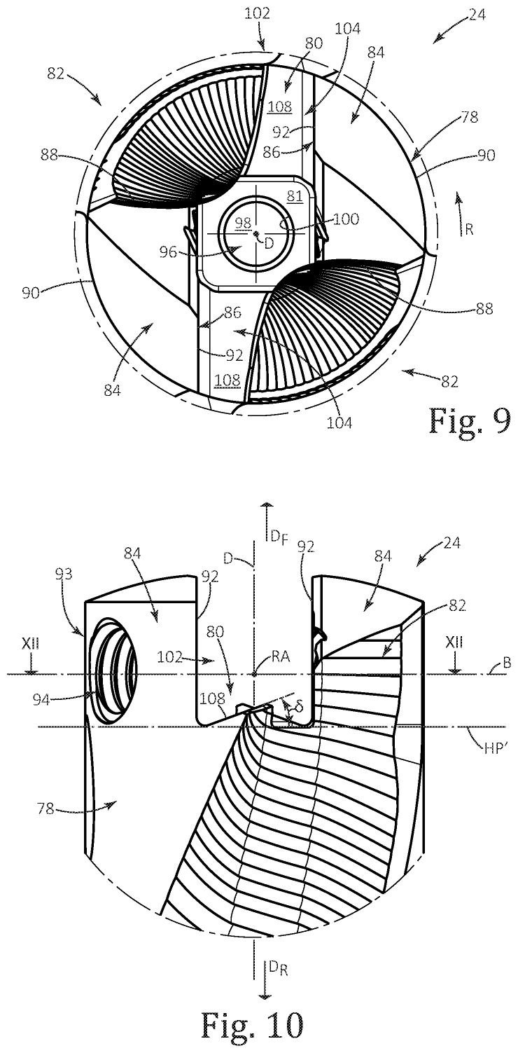

Referring back to FIG. 9, the tool holder 24 includes a head receiving pocket 102 formed between the two circumferentially spaced apart driving members 84. The head receiving pocket 102 includes two arm receiving receptacles 104. The two arm receiving receptacles 104 extend radially with respect to the holder longitudinal axis D. Each arm receiving receptacle 104 merges with an associated respective holder flute 82 in the rotation direction R and is delimited by an associated respective driving member 84 in a direction opposite the rotational direction R. In this non-limiting example shown in the drawings, the head receiving pocket 102 includes exactly two arm receiving receptacles 104, diametrically opposed to each other about the holder longitudinal axis D, and thus the head receiving pocket 102 is slot-like (see FIG. 10).

Each arm receiving receptacle 104 includes a receptacle rear abutment surface 108 located on the holder base surface 80. Referring to FIG. 10, for any given arm receiving receptacle 104 and its associated holder flute 82 and its associated driving member 84, the receptacle rear abutment surface 108 slopes forwardly in a direction away from the associated driving member 84 towards the associated holder flute 82. In a view along the receptacle axis RA (i.e., FIG. 10), the receptacle rear abutment surface 108 forms an acute receptacle rear dovetail angle δ with the radial holder plane HP′. The receptacle rear dovetail angle δ can fulfill the condition: 10°≤δ≤30°. Preferably, the receptacle rear dovetail angle δ can be equal to 20°. In accordance with some embodiments of the subject matter of the present application, the receptacle rear abutment surface 108 can be planar.

The tool holder 24 includes a holder centering hole 96, for receipt of the head centering pin 60 of the cutting head 22. The holder centering hole 96 is recessed in the holder base surface 80 and extends along the holder longitudinal axis D in the rearward direction D_{R}. The holder centering hole 96 includes a hole rear surface 98 that is spaced apart from the holder base surface 80 and a hole peripheral surface 100 that extends between the hole rear surface 98 and the holder base surface 80. In accordance with some embodiments of the subject matter of the present application, the holder centering hole 96 can be recessed in the planar holder central base surface 81. The hole peripheral surface 100 can have a cylindrical shape. The intersection of the hole peripheral surface 100 and the holder base surface 80 can be beveled to allow easy initial insertion of the head centering pin 60 when assembling the rotary cutting tool 20.

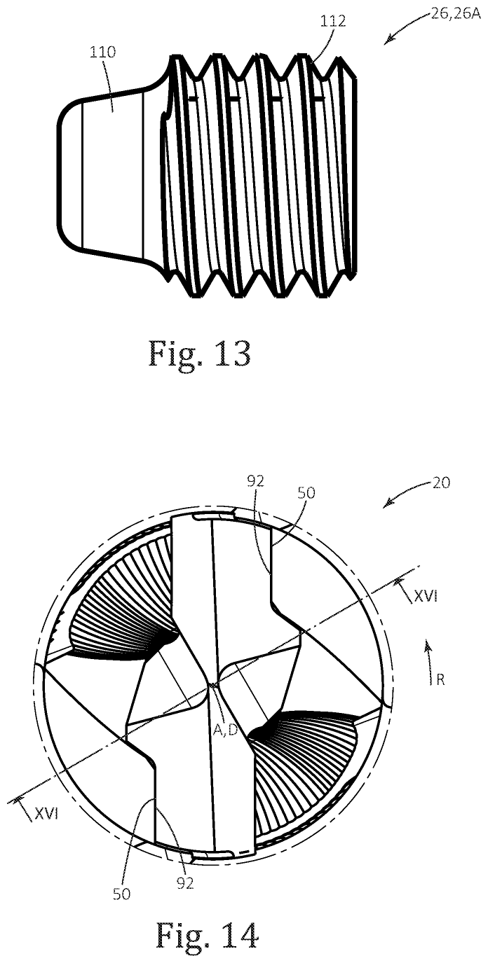

Attention is now made to FIG. 13, showing the fastening member 26. The fastening member 26 has a fastener biasing surface 110, for acting against the recess abutment surface 76. In accordance with some embodiments of the subject matter of the present application, the fastening member 26 can be a grub screw 26A, having an external thread 112. The fastener biasing surface 110 can be conical. Also, the fastener biasing surface 110 may be devoid of an external thread.

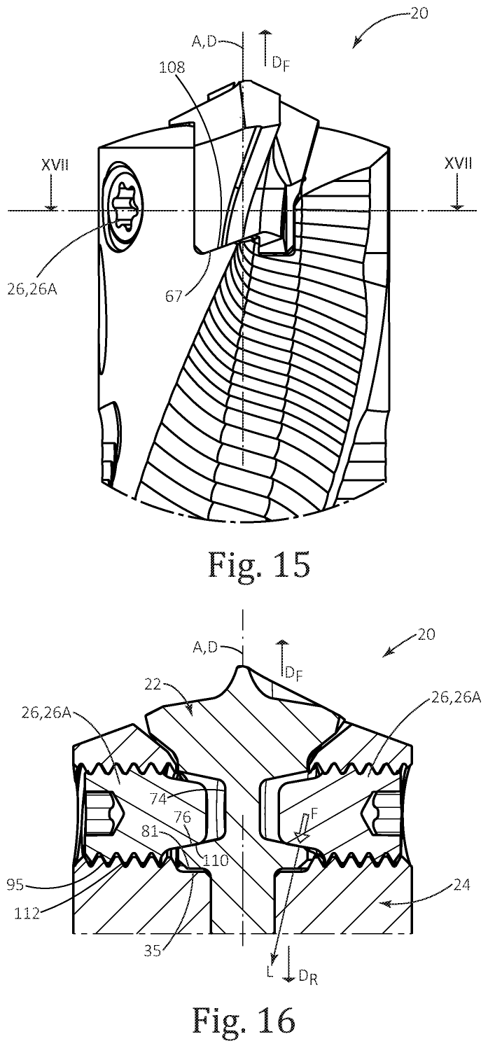

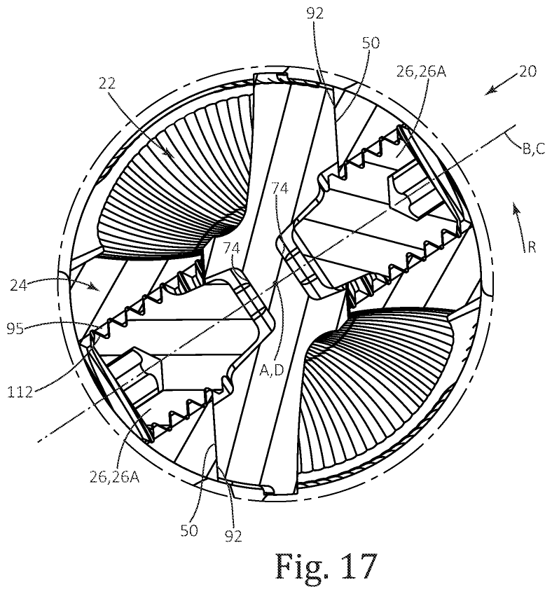

Another aspect of the subject matter of the present application relates to the rotary cutting tool 20, as shown in FIGS. 14-17. In the released position of the rotary cutting tool 20 the head centering pin 60 is not located in the holder centering hole 96. Also, the cutting head 22 is not releasably attached in the tool holder 24.

In the fastened position of the rotary cutting tool 20, the cutting head 22 is releasably attached in the tool holder 24, by the at least one fastening member 26. Preferably, the rotary cutting tool 20 can include exactly two fastening members 26. The head centering pin 60 is located in the holder centering hole 96. The head central axis A and the holder longitudinal axis D are co-axial. Each cutting arm 42 is in contact with a respective driving member 84. Specifically, each driven surface 50 abuts a respective driving surface 92. The at least one fastening member 26 is releasably attached to the tool holder 24. The at least one fastening member 26 is located in a respective driving member through hole 93 and abuts a respective fastening recess 70. Specifically, the fastener biasing surface 110 abuts the respective recess abutment surface 76. It is noted that the recess bottom surface 74 is spaced apart from the fastening member 26. In the configuration where the least one fastening member 26 is a grub screw 26A, the external thread 112 can be threadingly engaged with a respective internal thread 95.

Assembly of the rotary cutting tool 20 is accomplished by performing the following steps. The head centering pin 60 is positioned axially forward of, and facing towards, the holder centering hole 96. It should be noted that in this position each cutting arm 42 is located axially forward and circumferentially between, each adjacent pair of driving member 84 (i.e., rotationally aligned with a respective arm receiving receptacle 104, as best seen in FIG. 2). The cutting head 22 is then displaced rearwardly so that the head centering pin 60 is initially inserted in the holder centering hole 96. The cutting head 22 is then displaced further rearwardly until the head rear surface 34 initially comes into contact with the holder base surface 80. It is noted that the head central rear surface 35 is spaced apart from the holder central base surface 81. It should also be noted that the cutting arms 42 and the driving members 84 are so designed so that there is adequate space between each adjacent pair of driving members 84 to allow the placement of a cutting arm 42.

To adjust the cutting tool 20 into the fastened position, the cutting head 22 is now rotated in a direction against the rotational direction R, relative to the tool holder 24, until at least one of the driven surfaces 50 initially comes into contact with a respective driving surface 92. A first fastening member 26 is activated (e.g., tightened in the case of a screw) until it enters a first fastening recess 70 on the associated cutting arm 42 and comes into contact with the recess abutment surface 76 thereby exerting a fastening force F along a generally rearwardly directed line of force L thereon. The line of force L is perpendicular to the recess abutment surface 76. Since the line of force L has an axial (i.e., vertical) component, further tightening of the fastening member 26 urges the cutting arms 42 rearwardly towards the holder base surface 80. The sloping arm and receptacle rear abutment surfaces 67, 108 slide over each other. By virtue of the dovetail configuration of the respective pairs of arm and receptacle rear abutment surfaces 67, 108, each cutting arm 42 is urged towards the respective driving member 84 (so that the cutting head 22 rotates with respect to the tool holder 24) until each driven surface 50 abuts the respective driving surface 92, forming a fastened position of the rotary cutting tool 20. For improved fastening, a second fastening member 26 can be activated, either after full activation of the first fastening member 26, or in an alternating manner therewith, to engage with a second fastening recess 70.

It is noted in the configuration where the recess central axis C intersects the head central axis A, the fastening member(s) 26 exert no direct turning force (specifically directed in a direction opposite the rotational direction R about the head central axis A that urge the cutting arms 42 towards respective driving members 84. Conversely, in the configuration where the recess central axis C is offset from the head central axis A, the fastening member(s) 26 can exert such a turning force, in particular in the configuration where the recess abutment surface 76 converges with the arm rear abutment surface 67 in a direction away from the arm rotationally trailing surface 46 towards the arm rotationally leading surface 44.

Although the subject matter of the present application has been described to a certain degree of particularity, it should be understood that various alterations and modifications could be made without departing from the spirit or scope of the invention as hereinafter claimed.

What is claimed is:

1. A cutting head (22) having a head central axis (A) defining opposite forward to rearward direction (D_{F}, D_{R}) and about which the cutting head (22) is rotatable in a rotational direction (R), the cutting head (22) comprising a cutting portion (28);
the cutting portion (28) comprising:
opposite head front and rear end surfaces (32, 34) and a head peripheral surface (36) extending therebetween;
two cutting arms (42), each cutting arm (42) extending radially outwards with respect to the head central axis (A) along an arm axis (AA) and comprising:
opposite arm rotationally leading and trailing surfaces (44, 46) located on the head peripheral surface (36), the arm rotationally leading surface (44) being ahead of the arm rotationally trailing surface (46) in the rotational direction (R);
a forwardly disposed major cutting edge (54) formed along at least a portion of an intersection of the arm rotationally leading surface (44) and the head front surface (32);
an arm rear abutment surface (67) located on the head rear surface (34), the arm rear abutment surface (67) sloping forwardly in a direction away from the arm rotationally trailing surface (46) towards the arm rotationally leading surface (44);
a driven surface (50) located on the arm rotationally trailing surface (46); and
at least one fastening recess (70) opening out at a recess opening (71) located at least partially on the arm rotationally trailing surface (46) of a respective cutting arm (42) associated with the at least one fastening recess (70); wherein:
the at least one fastening recess (70) comprises a recess circumferential surface (72) extending about a recess central axis (C), the recess circumferential surface (72) comprising a recess abutment surface (76) oriented transversely to the head central axis (A) and facing away from the head rear surface (34).

2. The cutting head (22), according to claim 1, wherein:
the recess central axis (C) intersects the head central axis (A).

3. The cutting head (22), according to claim 1, wherein:
for any given fastening recess (70) and its associated cutting arm (42), the recess abutment surface (76) converges with the arm rear abutment surface (67) in a direction away from the arm rotationally trailing surface (46) towards the arm rotationally leading surface (44).

4. The cutting head (22), according to claim 1, further comprising a centering portion (30); wherein:
the head rear surface (34) defines a boundary between the cutting portion (28) and the centering portion (30);
the centering portion (30) comprises a head centering pin (60) protruding rearwardly from the head rear surface (34) along the head central axis (A).

5. The cutting head (22), according to claim 1, wherein:
in a view along the arm axis (AA), the recess abutment surface (76) and the arm rear abutment surface (67) form an acute arm engagement angle (α); and
the arm engagement angle (α) fulfills the condition: 5°≤α≤10°.

6. The cutting head (22), according to claim 1, wherein:
in a view along the arm axis (AA), the arm rear abutment surface (67) forms an acute arm rear dovetail angle (β) with a radial head plane (HP) oriented perpendicularly to the head central axis (A); and
the arm rear dovetail angle (β) fulfills the condition: 10°≤β≤30°.

7. The cutting head (22), according to claim 1, wherein:
the recess abutment surface (76) slopes forwardly in a direction away from the recess opening (71).

8. The cutting head (22), according to claim 7, wherein:
in a view along the arm axis (AA), the recess abutment surface (76) forms a recess abutment angle (θ) with a radial head plane (HP) oriented perpendicularly to the head central axis (A); and
the recess abutment angle (θ) fulfills the condition: 15°≤θ≤25°.

9. The cutting head (22), according to claim 1, wherein:
the cutting portion (28) comprises exactly two cutting arms (42) diametrically opposed to one another about the head central axis (A).

10. The cutting head (22), according to claim 10, wherein:
the cutting portion (28) comprises exactly two fastening recesses (70), each fastening recess (70) being associated with a different cutting arm (42).

11. The cutting head (22), according to claim 10, wherein:
the cutting portion (28) comprises:
a head radially central portion (40); wherein:
the exactly two cutting arms (42) extend radially outwardly from the head radially central portion (40); and
the cutting portion (28) comprises exactly two opposing chip breaker wings (77) extending radially outwardly from the head radially central portion (40), each chip breaker wing (77) being located between the exactly two cutting arms (42).

12. The cutting head (22), according to claim 11, wherein:
the exactly two cutting arms (42) define a head outer diameter (OD);
the exactly two chip breaker wings (77) define a wing spanning dimension (WD) measured in a direction normal to the driven surfaces (50); and
the wing spanning dimension (WD) is greater than half the head outer diameter (OD).

13. The cutting head (22), according to claim 1, wherein:
the cutting portion (28) is devoid of insert seats configured to receive a cutting insert.

14. The cutting head (22), according to claim 1, wherein:
the at least one fastening recess (70) is blind and does not penetrate the entire thickness of the respective cutting arm (42) so as to intersect both the rotationally leading surface (44) and the rotationally trailing surface (46) of said respectively cutting arm (42).

15. A tool holder (24), having a holder longitudinal axis (D), extending in opposite forward to rearward direction (D_{F}, D_{R}) and about which the tool holder (24) is rotatable in a rotational direction (R), the tool holder (24) comprising:
a holder peripheral surface (78) extending circumferentially along the holder longitudinal axis (D) and forming a boundary of a forwardly facing holder base surface (80) at a forward end of the tool holder (24);
two circumferentially spaced apart holder flutes (82) recessed in the holder peripheral surface (78) and extending helically about the holder longitudinal axis (D);
two circumferentially spaced apart driving members (84) extending forwardly from the holder base surface (80), each driving member (84) comprising:
driving member rotationally leading and trailing surfaces (86, 88), the driving member rotationally leading surface (86) being ahead of the driving member rotationally trailing surface (88) in the rotational direction (R);
a driving surface (92) located on the driving member rotationally leading surface (84), and
at least one driving member through hole (93) extending along a driving member through hole axis (B) and opening out to the driving member rotationally leading surface (86) and the holder peripheral surface (78); and
a head receiving pocket (102) formed between the two circumferentially spaced apart driving members (84), the head receiving pocket (102) comprising two arm receiving receptacles (104), each arm receiving receptacle (104) extending radially outwards with respect to the holder longitudinal axis (D) along a receptacle axis (RA) and merging with an associated respective holder flute (82) in the rotation direction (R) and being delimited by an associated respective driving member (84) in a direction opposite the rotational direction (R); wherein:
each arm receiving receptacle (104) comprises a receptacle rear abutment surface (108) located on the holder base surface (80); and
for any given arm receiving receptacle (104) and its associated holder flute (82) and its associated driving member (84), the receptacle rear abutment surface (108) slopes forwardly in a direction away from the associated driving member (84) towards the associated holder flute (82).

16. The tool holder (24), according to claim 15, wherein:
the through hole central axis (B) intersects the holder longitudinal axis (D).

17. The tool holder (24), according to claim 15, further comprising:
a holder centering hole (96) recessed in the holder base surface (80) and extending along the holder longitudinal axis (D) in the rear direction (D_{R}).

18. The tool holder (24), according to claim 15, wherein:
the tool holder (24) comprises exactly two circumferentially spaced apart driving members (84).

19. The tool holder (24), according to claim 18 wherein:
the tool holder (24) comprises exactly two driving member through holes (93), each driving member through hole (93) being formed in a different driving member (84).

20. The tool holder (24), according to claim 15, wherein:
in a view along the receptacle axis (RA), the receptacle rear abutment surface (108) forms an acute receptacle rear dovetail angle (δ) with a radial holder plane (HP′) oriented perpendicularly to the holder longitudinal axis (D); and
the receptacle rear dovetail angle (δ) fulfills the condition: 10°≤δ≤30°.

21. The tool holder (24), according to claim 15, wherein:
the driving member through hole (93) comprises a through hole peripheral surface (94) extending about the through hole central axis (B); and
the through hole peripheral surface (94) comprises an internal thread (95).

22. A rotary cutting tool (20) comprising:
a cutting head (22), in accordance with claim 1;
a tool holder (24) having a holder longitudinal axis (D), extending in opposite forward to rearward direction (D_{F}, D_{R}) and about which the tool holder (24) is rotatable; and
at least one fastening member (26); wherein:
the rotary cutting tool (20) is adjustable between a released position, and a fastened position in which the cutting head (22) is releasably attached to the tool holder (24) by the at least one fastening member (26).

23. A rotary cutting tool (20) comprising:
a cutting head (22), in accordance with claim 1;
a tool holder (24), in accordance with claim 15: and
at least one fastening member (26); wherein:
the rotary cutting tool (20) is adjustable between a released position and a fastened position, wherein, in the fastened position:
the cutting head (22) is releasably attached to the tool holder (24) by the at least one fastening member (26);
the head centering pin (60) is located in the holder centering hole (96);
each cutting arm (42) is located in a respective arm receiving receptacle (104);
each driven surface (50) abuts a respective driving surface (92);
each arm rear abutment surface (67) abuts a respective receptacle abutment surface (108); and
the at least one fastening member (26) engages the recess abutment surface (76) of the at least one fastening recess (26).

24. The rotary cutting tool (20), according to claim 23, wherein:
the driving member through hole (93) comprises a through hole peripheral surface (94) extending about the through hole central axis (B);
the through hole peripheral surface (94) comprises an internal thread (95); and
the at least one fastening member (26) is a grub screw (26A) having an external thread (112) threadingly engaged with the internal thread (95).

25. The rotary cutting tool (20), according to claim 23, wherein:
the cutting portion (28) comprises exactly two cutting arms (42) diametrically opposed to one another about the head central axis (A);
exactly two fastening recesses (70), each fastening recess (70) being associated with a different cutting arm (42);
the tool holder (24) comprises exactly two circumferentially spaced apart driving members (84);
the tool holder (24) comprises exactly two driving member through holes (93), each driving member through hole (93) being formed in a different driving member (84); and
the rotary cutting tool (20) comprises exactly two fastening members (26).

26. A cutting head (22) having a head central axis (A) defining opposite forward to rearward direction (D_{F}, D_{R}) and about which the cutting head (22) is rotatable in a rotational direction (R), the cutting head (22) comprising a cutting portion (28);
the cutting portion (28) being devoid of insert seats configured to receive a cutting insert, and comprising:
opposite head front and rear end surfaces (32, 34) and a head peripheral surface (36) extending therebetween;
two cutting arms (42), each cutting arm (42) extending radially outwards with respect to the head central axis (A) along an arm axis (AA) and comprising:
opposite arm rotationally leading and trailing surfaces (44, 46) located on the head peripheral surface (36), the arm rotationally leading surface (44) being ahead of the arm rotationally trailing surface (46) in the rotational direction (R);
a forwardly disposed major cutting edge (54) formed along at least a portion of an intersection of the arm rotationally leading surface (44) and the head front surface (32);
an arm rear abutment surface (67) located on the head rear surface (34);
a driven surface (50) located on the arm rotationally trailing surface (46); and
at least one fastening recess (70) opening out at a recess opening (71) located at least partially on the arm rotationally trailing surface (46) of a respective cutting arm (42) associated with the at least one fastening recess (70); wherein:
the at least one fastening recess (70) comprises a recess circumferential surface (72) extending about a recess central axis (C), the recess circumferential surface (72) comprising a recess abutment surface (76) oriented transversely to the head central axis (A) and facing away from the head rear surface (34); and
the at least one fastening recess (70) is blind and does not penetrate the entire thickness of the respective cutting arm (42).so as to intersect both the rotationally leading surface (44) and the rotationally trailing surface (46) of said respectively cutting arm (42).
